(19) United States
(12) Patent Application Publication
(10) Pub. No.: US 2026/0021565 A1
(43) Pub. Date: Jan. 22, 2026

(54) GAS SPRING-POWERED FASTENER DRIVER

(71) Applicant: MILWAUKEE ELECTRIC TOOL CORPORATION, Brookfield, WI (US)

(72) Inventors: Marcus M. Wechselberger, Milwaukee, WI (US); Garrett J. Kocourek, Milwaukee, WI (US); David A. Bierdeman, New Berlin, WI (US); David C. Graf, Greendale, WI (US)

(21) Appl. No.: 19/271,422

(22) Filed: Jul. 16, 2025

Related U.S. Application Data
(60) Provisional application No. 63/673,071, filed on Jul. 18, 2024.

(51) Int. Cl. B25C 1/00

(52) U.S. Cl. CPC B25C 1/005

(57) ABSTRACT

A magazine assembly including a body having a first end, a second end opposite the first end, a first side, a second side opposite the first side, a third side, and a fourth side opposite the third side. A rib extends from the body and is positioned adjacent to the second side. A fastener channel extends between the first end and the second end. A first elongate channel is positioned in the first side of the body and extends between the first end and the second end, and a second elongate channel is positioned in the second side of the body and extends between the first end and the second end. A first insert is positioned within the first elongate channel and partially extends into the fastener channel and a second insert is positioned within the second elongate channel and partially extends into the fastener channel.

### CROSS-REFERENCE TO RELATED APPLICATIONS

This application claims priority to U.S. Provisional Patent Application No. 63/673,071, filed on Jul. 18, 2024, the entire contents of which is incorporated herein by reference.

### FIELD OF THE INVENTION

The present invention relates to powered fastener drivers, and more specifically to gas spring-powered fastener drivers.

### BACKGROUND OF THE INVENTION

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.), but often these designs are met with power, size, and cost constraints.

### SUMMARY OF THE INVENTION

In some aspects, the techniques described herein relate to a magazine assembly for use with a powered fastener driver including a nosepiece, the magazine assembly including: a body having a first end configured to be coupled to the nosepiece, a second end opposite the first end, a first side, a second side opposite the first side, a third side, and a fourth side opposite the third side, and a rib extending from the body and positioned adjacent to the second side, a fastener channel extending between the first end and the second end, the fastener channel configured to receive fasteners, a first elongate channel positioned in the first side of the body and extending between the first end and the second end, the first elongate channel opens to the fastener channel, a second elongate channel positioned in the second side of the body and extending between the first end and the second end, the second elongate channel opens to the fastener channel, the first elongate channel and the second elongate channel being on an opposite sides of the fastener channel; a first insert positioned within the first elongate channel and partially extending into the fastener channel, and a second insert positioned within the second elongate channel and partially extending into the fastener channel.

In some aspects, the techniques described herein relate to a powered fastener driver including: a housing; a nosepiece extending from the housing and including a firing channel from which consecutive fasteners are driven; a magazine assembly including a body having a first end coupled to the nosepiece, a second end opposite the first end, a first side, a second side opposite the first side, a third side, and a fourth side opposite the third side, the first side including an aperture extending therethrough, the aperture including a first portion and a second portion, a maximum width of the second portion being greater than a maximum width of the first portion, a fastener channel extending between the first end and the second end, the fastener channel configured to receive fasteners and in communication with the firing channel, a first elongate channel positioned in the first side of the body and extending between the first end and the second end, the first elongate channel opens to the fastener channel, a second elongate channel positioned in the second side of the body and extending between the first end and the second end, the second elongate channel opens to the fastener channel, the first elongate channel and the second elongate channel being on an opposite sides of the fastener channel, a first insert positioned within the first elongate channel and partially extending into the fastener channel, and a second insert positioned within the second elongate channel and partially extending into the fastener channel; a bolt threadably coupled to a threaded aperture in the housing, wherein the magazine assembly is removable from the nosepiece, wherein magazine assembly is movable relative to the housing, the nosepiece, and the bolt between a first position and a second position, wherein when the magazine assembly is in the first position, the bolt extends through the first portion of the aperture and when the magazine assembly is in the second position, the bolt extends through the second portion of the aperture, and wherein when the magazine assembly is in the first position, the magazine assembly is securable to the housing by the bolt to the housing, and when the magazine assembly is in the second position, the magazine assembly is removable from the housing.

In some aspects, the techniques described herein relate to a magazine assembly for use with a powered fastener driver including a nosepiece, the magazine assembly including: a body having a first end configured to be coupled to the nosepiece, a second end opposite the first end, a first side, a second side opposite the first side, a third side, and a fourth side opposite the third side, a maximum thickness of the second side being greater than a maximum thickness of the first side; a fastener channel extending between the first end and the second end, the fastener channel configured to receive fasteners; a first elongate channel positioned in the first side of the body and extending between the first end and the second end, the first elongate channel opens to the fastener channel, a second elongate channel positioned in the second side of the body and extending between the first end and the second end, the second elongate channel opens to the fastener channel, the first elongate channel and the second elongate channel being on an opposite sides of the fastener channel; a first insert positioned within the first elongate channel and partially extending into the fastener channel; and a second insert positioned within the second elongate channel and partially extending into the fastener channel.

In some aspects, the techniques described herein relate to a method for manufacturing a magazine assembly, the method including: forming, by extrusion, a body of the magazine assembly, the body including a first end configured to be coupled to a nosepiece, a second end opposite the first end, a first side, a second side opposite the first side, a third side, and a fourth side opposite the third side, a maximum thickness of the second side being greater than a maximum thickness of the first side; and a fastener channel extending between the first end and the second end, the fastener channel configured to receive fasteners; machining the body to remove material from the first end, the second end, and at least one of the first side, the second side, the third side, and the fourth side.

Other features and aspects of the invention will become apparent by consideration of the following detailed description and accompanying drawings.

### BRIEF DESCRIPTION OF THE DRAWINGS

FIG. 1 is perspective view of a gas spring-powered fastener driver in accordance with an embodiment of the invention and including a magazine assembly.

FIG. 2 is another perspective view of the gas spring-powered fastener driver of FIG. 1.

FIG. 3 is another perspective view of the gas spring-powered fastener driver of FIG. 1.

FIG. 4A is another partial cut-away view of the gas spring-powered fastener driver of FIG. 1, with portions removed for clarity.

FIG. 4B is a front view of a lifting assembly and latch actuator assembly.

FIG. 4C is a front view of the lifting assembly of FIG. 4B and the latch actuator assembly of FIG. 4B illustrating the latch in a latched state.

FIG. 5 is a partial cross-sectional view of the gas spring-powered fastener driver taken along line 5-5 in FIG. 1.

FIG. 6A is a schematic view of the gas spring-powered fastener driver of FIG. 1, illustrating a driver blade in a driven or bottom-dead-center position.

FIG. 6B is a schematic view of the gas spring-powered fastener driver of FIG. 1, illustrating a driver blade in a top-dead-center position prior to actuation.

FIG. 7 is a perspective view of a body of the magazine assembly of the gas spring-powered fastener driver of FIG. 1.

FIG. 8 is a cross-sectional view of the body of the magazine assembly of FIG. 7.

FIG. 9 is a detailed perspective cross-sectional view of the magazine assembly of FIG. 1.

FIG. 10 is another detailed cross-sectional view of the magazine assembly of FIG. 1.

FIG. 11 is a body of another magazine assembly for use with the gas spring-powered fastener driver of FIG. 1.

FIG. 12 is a cross-sectional view of the magazine assembly of FIG. 11.

FIG. 13 is a cross-sectional view of the body of the magazine assembly of FIG. 11.

FIG. 14 is a body of another magazine assembly for use with the gas spring-powered fastener driver of FIG. 1.

FIG. 15 is a cross-sectional view of the body of the magazine assembly of FIG. 14.

FIG. 16 is a body of another magazine assembly for use with the gas spring-powered fastener driver of FIG. 1.

FIG. 17 is a cross-sectional view of the body of the magazine assembly of FIG. 14.

FIG. 18 is a cross-sectional view of a body of another magazine assembly for use with the gas spring-powered fastener driver of FIG. 1.

FIG. 19 is a cross-sectional view of a body of another magazine assembly for use with the gas spring-powered fastener driver of FIG. 1.

FIG. 20 is a cross-sectional view of a body of another magazine assembly for use with the gas spring-powered fastener driver of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

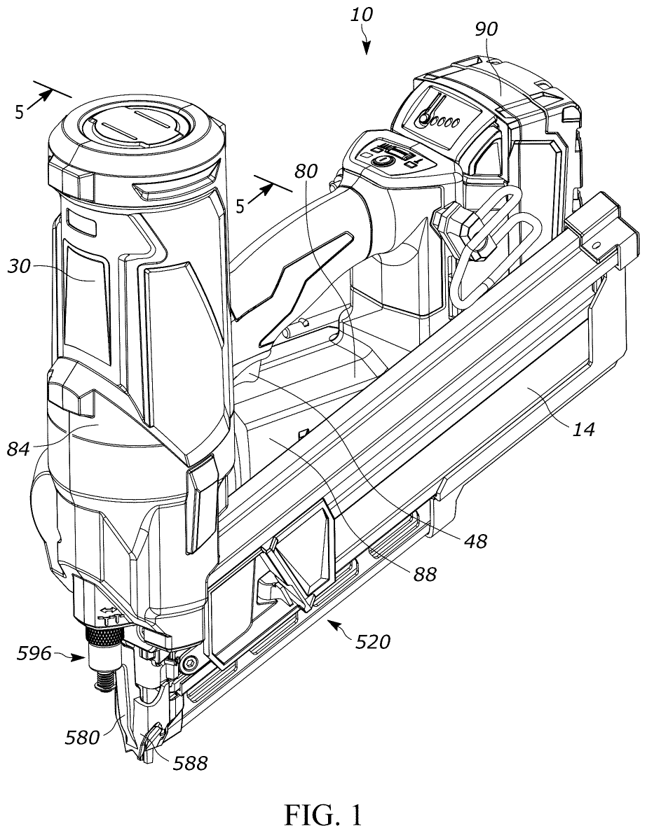

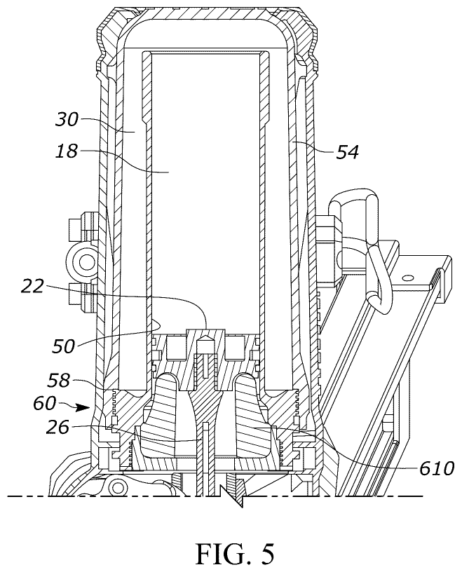

With reference to FIGS. 1-3, a gas spring-powered fastener driver 10 is operable to drive fasteners (e.g., nails, tacks, staples, etc.) held within a magazine assembly 14 into a workpiece. The fastener driver 10 includes an inner cylinder 18 and a moveable piston 22 positioned within the cylinder 18 (FIG. 5). With reference to FIG. 5, the fastener driver 10 further includes a driver blade 26 that is attached to the piston 22 and moveable therewith. The fastener driver 10 does not require an external source of air pressure, but rather includes a storage chamber cylinder 30 of pressurized gas in fluid communication with the cylinder 18. In the illustrated embodiment, the cylinder 18 and moveable piston 22 are positioned within the storage chamber cylinder 30. The driver 10 further includes a fill valve (not shown) coupled to the storage chamber cylinder 30. When connected with a source of compressed gas, the fill valve permits the storage chamber cylinder 30 to be refilled with compressed gas if any prior leakage has occurred. The fill valve may be configured as a Schrader valve, for example.

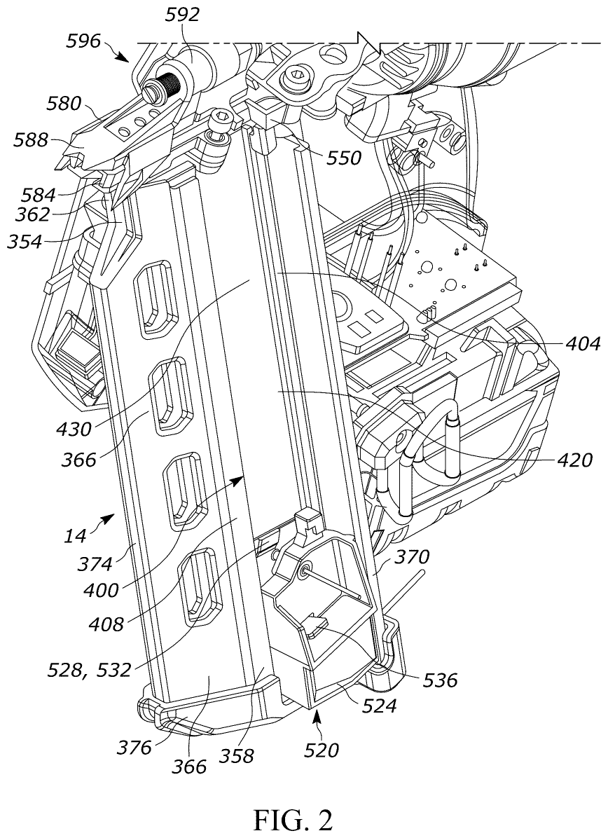

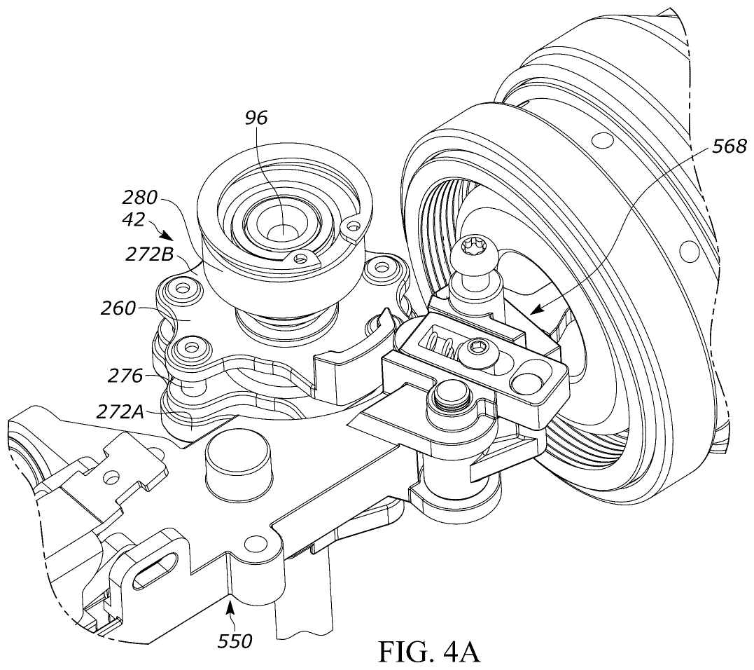

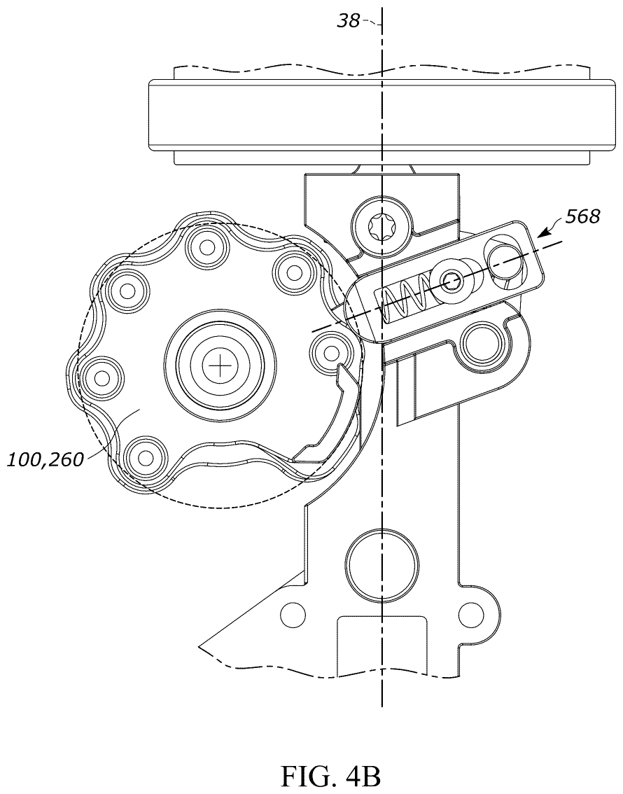

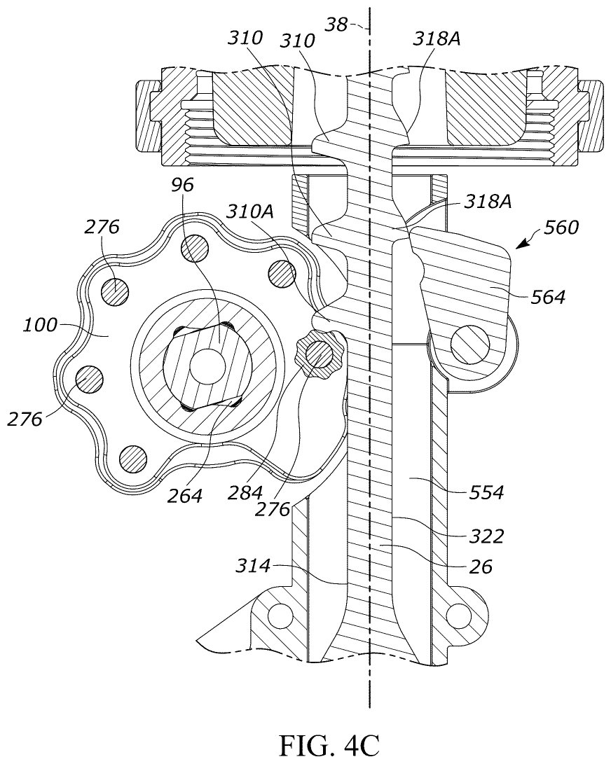

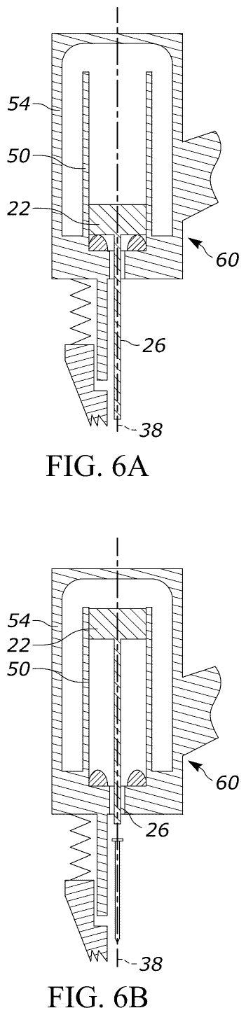

With reference to FIGS. 4A-6B, the cylinder 18 and the driver blade 26 define a driving axis 38 (FIG. 5). During a driving cycle, the driver blade 26 and piston 22 are moveable between a top-dead-center (TDC) position (FIG. 6B) and a driven or bottom-dead-center (BDC) position (FIG. 6A). The fastener driver 10 further includes a lifting assembly 42 (FIGS. 4A-4C), which is powered by a motor 46 (FIG. 2), and which is operable to move the driver blade 26 from the driven position to the TDC position.

In operation, the lifting assembly 42 drives the piston 22 and the driver blade 26 toward the TDC position by energizing the motor 46. As the piston 22 and the driver blade 26 are driven toward the TDC position, the gas above the piston 22 and the gas within the storage chamber cylinder 30 is compressed. Prior to reaching the TDC position, the motor 46 is deactivated and the piston 22 and the driver blade 26 are held in a ready position, which is located between the TDC and the BDC or driven positions, until being released by user activation of a trigger 48 (FIG. 1). When released, the compressed gas above the piston 22 and within the storage chamber cylinder 30 drives the piston 22 and the driver blade 26 to the driven position, thereby driving a fastener into the workpiece. The illustrated fastener driver 10 therefore operates on a gas spring principle utilizing the lifting assembly 42 and the piston 22 to further compress the gas within the cylinder 18 and the storage chamber cylinder 30. Further detail regarding the structure and operation of the fastener driver 10 is provided below.

With reference to FIGS. 5 and 6A-6B, the storage chamber cylinder 30 is concentric with the cylinder 18. The cylinder 18 has an annular inner wall 50 configured to guide the piston 22 and driver blade 26 along the driving axis 38 to compress the gas in the storage chamber cylinder 30. The storage chamber cylinder 30 has an annular outer wall 54 circumferentially surrounding the inner wall 50. The cylinder 18 has a threaded section 58 (FIG. 5). The storage chamber cylinder 30 has corresponding threads at a lower end 60 of the storage chamber cylinder 30 such that the cylinder 18 is threadably coupled to the storage chamber cylinder 30 at the lower end 60. As such, the cylinder 18 is configured to be axially secured to the storage chamber cylinder 30. The threaded coupling may facilitate and simplify assembly of the driver 10.

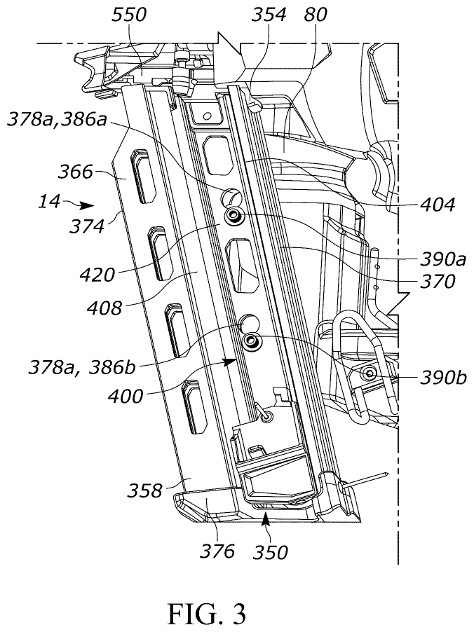

With reference to FIG. 1, the driver 10 includes a housing 80 having a cylinder support portion 84 in which the storage chamber cylinder 30 is at least partially positioned and a drive unit support portion 88 in which the motor 46 and a transmission (not shown) are at least partially positioned. In the illustrated embodiment, the cylinder support portion 84 is integrally formed with the drive unit support portion 88 as a single piece (e.g., using a casting or molding process, depending on the material used). As described below in further detail, the transmission which raises the driver blade 26 from the driven position to the ready position. With reference to FIG. 3, the motor 46 is positioned within the drive unit support portion 88 for providing torque to the transmission when activated. A battery 90 is electrically connectable to the motor 46 for supplying electrical power to the motor 46. In alternative embodiments, the driver may be powered from an AC voltage input (i.e., from a wall outlet), or by an alternative DC voltage input (e.g., an AC/DC converter).

Although not shown in detail, the transmission includes an input (i.e., a motor output shaft) and an output shaft 96 extending to a lifter 100, which is operable to move the driver blade 26 from the driven position to the ready position, as explained in greater detail below. In other words, the transmission provides torque to the lifter 100 from the motor 46. The transmission is configured as a planetary transmission having first, second, and third planetary stages. In alternative embodiments, the transmission may be a single-stage planetary transmission, or a multi-stage planetary transmission including any number of planetary stages.

With reference to FIGS. 4A-4C, the lifter 100, which is a component of the lifting assembly 42, is coupled for co-rotation with the transmission output shaft 96. The lifter 100 includes a hub 260 having an opening 264 (FIG. 5). An end of the transmission output shaft 96 extends through the opening 264 and is rotatably secured to the lifter 100. With continued reference to FIG. 4A, the hub 260 is formed by upper and lower plates 272A, 272B, and includes multiple drive pins 276 (FIG. 5) extending between the upper and lower plates 272A, 272B. The illustrated lifter 100 includes seven drive pins 276; however, in other embodiments, the lifter 100 may include three or more drive pins 276. The drive pins 276 are sequentially engageable with the driver blade 26 to raise the driver blade 26 from the driven position to the ready position. The lifting assembly 42 further includes a bearing 280 positioned proximate the upper plate 272A. The bearing 280 is configured to rotatably support the transmission output shaft 96.

With reference to FIGS. 4C-5, the lifter 100 further includes roller bushings 284 positioned on each of the drive pins 276. The roller bushings 284 are configured to facilitate rolling motion between the driver pins 276 and the driver blade 26 when raising the driver blade 26 from the driven portion to the ready position. This may reduce wear on the driver blade 26 (i.e., teeth) and/or the lifter 100 which may increase the life of the driver 10.

With reference to FIG. 5, the driver blade 26 includes teeth 310 along the length thereof, and the respective roller bushings 284 are engageable with the teeth 310 when returning the driver blade 26 from the driven position to the ready position. As shown, the teeth 310 extend from a first side 314 of the driver blade 26.

Further with respect to FIG. 5, the driver blade 26 further includes axially spaced projections 318, the purpose of which is described below, formed on a second side 322 opposite the teeth 310. The illustrated driver blade 26 is manufactured such that each of the teeth 310 and the projections 318 are in the same plane (i.e., flat) as the driver blade 26. This may simplify manufacturing of the driver blade 26, and reduce the stresses applied to the driver blade 26 (i.e., the teeth 310, the projection 318, etc.).

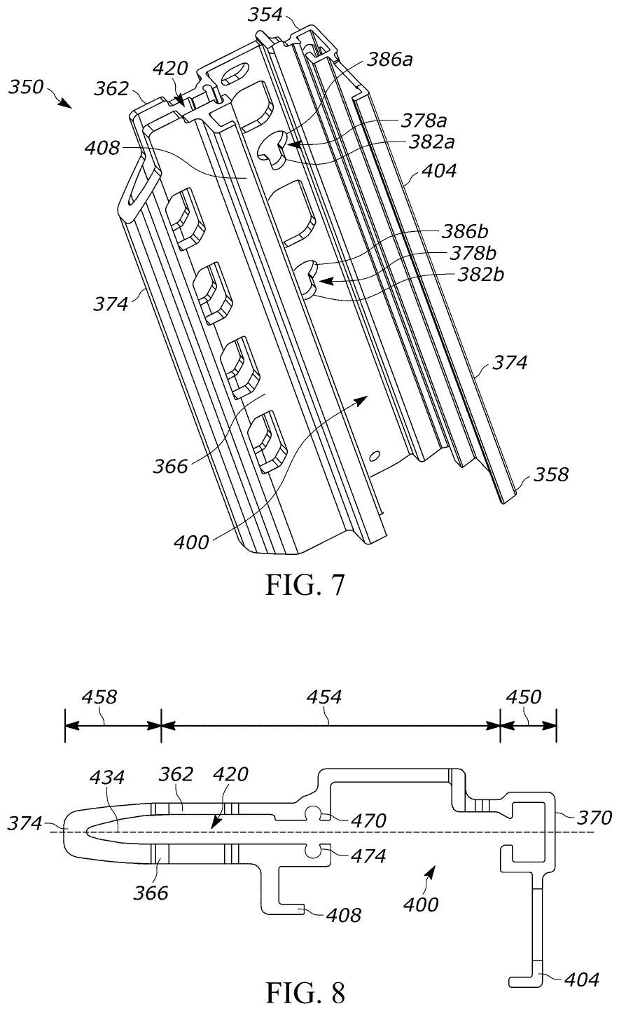

As shown in FIGS. 2, 3, and 7, the magazine assembly 14 includes a body 350 including a first end 354, a second end 358 opposite the first end 354, a first side 362, a second side 366 opposite the first side 362, a third side 370, and a fourth side 374 opposite the third side 370. An end cap 376 is coupled to the second end 358. As shown in FIGS. 3 and 7, the first side 362 includes a first aperture 378a and a second aperture 378b. Each of the first aperture 378a and second aperture 378b includes a first portion 382a, 382b and a second portion 386a, 386b. A maximum width of the second portion 386a, 386b is greater than a maximum width of the first portion 382a, 382b. The first aperture 378a, 378b in the body 350 is adjacent to a first threaded aperture (not shown) in the housing 80 and the second aperture 378b is adjacent to a second threaded aperture (not shown) in the housing 80. As shown in FIG. 3, a first bolt 390a extends through the first aperture 378a and is threadably received within the first threaded aperture of the housing 80. A second bolt 390b extends through the second aperture 378b and is threadably received in the second threaded aperture of the housing 80. The maximum width of each of the first portions 382a, 382b is generally less than a maximum width of the head of the respective bolt 390a, 390b, while the maximum width of each of the second portions 386a, 386b is generally greater than a maximum width of the head of the respective bolt 390a, 390b. The first and second bolts 390a, 390b, when positioned in the first portion 382a, 382b of the respective aperture 378a, 378b and tightened, couple the magazine assembly 14 to the housing 80. The magazine assembly 14 is removable from the driver 10, as will be discussed in greater detail below.

The second side 366 includes an opening 400 that extends along a height of the body 350 between the first end 354 and the second end 358. A first rail 404 extends from the second side 366 and a second rail 408 extends from the second side 366. The first rail 404 and the second rail 408 are positioned on opposite sides of the opening 400. The first rail 404 and the second rail 408 both extend along the height of the body 350 between the first end 354 and the second end 358.

With respect to FIGS. 7 and 8, the body 350 of the magazine assembly 14 defines a fastener channel 420 that receives a collation of fasteners 430. The collation of fasteners 430 is movable through the fastener channel 420, as will be discussed below. As shown in FIG. 7, the fastener channel 420 includes a head portion 450 and a shank portion 454, and a tip portion 458. The fastener channel 420 includes an axis 434 extending from the head portion 450 to tip portion 458. The head portion 450 extends from the third side 370 towards the fourth side 374 and receives heads of the fasteners 430. The shank portion 454 extends from the head portion 450 towards the fourth side 374 and receives shanks of fasteners 430. The tip portion 458 extends from the shank portion 454 to the fourth side 374 and receives tips of the fasteners 430. The head portion 450 and the shank portion 454 of the fastener channel 420 extend along the height of the body 350 of the magazine assembly 14 between the first end 354 and the second end 358. The tip portion 458 of the fastener channel 420 extends partially along the height of the body 350 of the magazine assembly 14 between the first end 354 and the second end 358.

With respect to FIGS. 8-10, a first elongate channel 470 is positioned in the first side 362 of the body 350, and a second elongate channel 474 is positioned in the second side 366 of the body 350. The first elongate channel 470 and the second elongate channel 474 both extend at least partially along the height of the body 350 between the first end 354 and the second end 358. The first elongate channel 470 and the second elongate channel 474 are positioned on opposite sides of the fastener channel 420. Specifically, the first elongate channel 470 and the second elongate channel 474 are positioned on opposite sides of the shank portion 454 of the fastener channel 420. Each of the first and second elongate channels 470, 474 open to the fastener channel 420, and in particular, the shank portion 454 of the fastener channel 420. Additionally, the first elongate channel 470 and the second elongate channel 474 are positioned closer to the fourth side 374 than the third side 370. Even further, the first elongate channel 470 and the second elongate channel 474 are positioned between the second rail 408 and the fourth side 374.

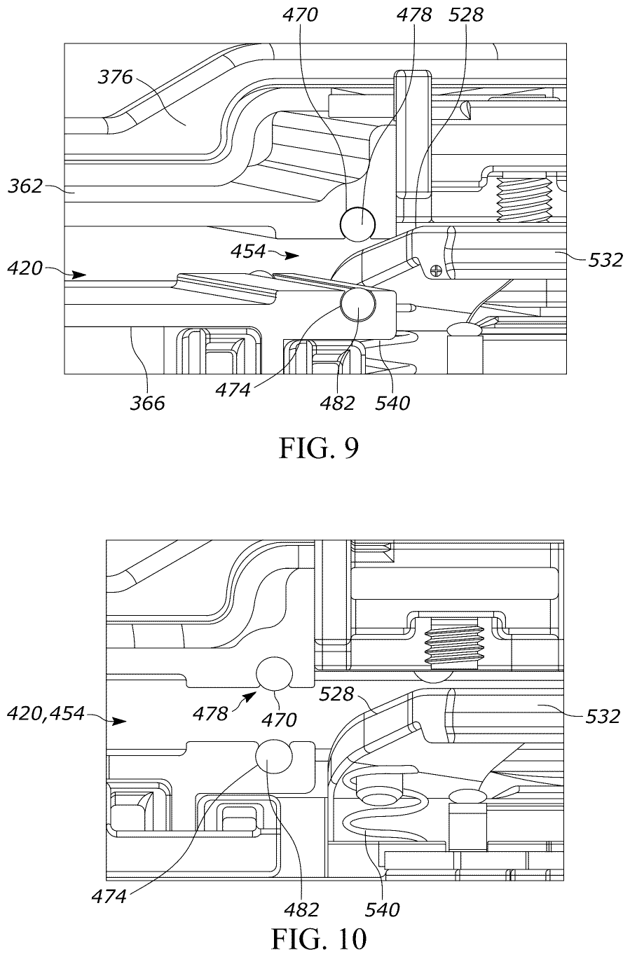

As shown in FIGS. 9 and 10, a first insert 478 is positioned within the first elongate channel 470 and a second insert 482 is positioned within the second elongate channel 474. The first insert 478 and the second insert 482 partially extend into the fastener channel 420. In the illustrated embodiment, the inserts 478, 482 have a circular cross-section, but in other embodiments, the inserts 478, 482 may have other cross-sectional shapes (e.g., a square cross-section, a rectangular cross-section, a polygonal cross-section, etc.). The inserts 478, 482 are formed from a material that is harder than a material of the body 350 of the magazine assembly 14, such that any wear resulting from frictional contact between the fasteners 430 as they advance through the magazine assembly 14 is imparted to inserts 478, 482 and the not the magazine assembly 14. Specifically, the inserts 478, 482 contact the shanks of the fasteners 430. The inserts 478, 482 have a height that is at least as long as the collated strip of fasteners 430 received in the magazine assembly 14. In some embodiments, the inserts 478, 482 may extend along the height of the body 350.

In the illustrated embodiment, the body 350 of the magazine assembly 14 is preferably formed from magnesium or aluminum. In other embodiments, the body 350 of the magazine assembly 14 may be formed from plastic, steel, another suitable material, or a combination of materials. The first insert 478 and the second insert 482 may be constructed from aluminum, stainless steel, steel, plastic, another suitable material with a greater hardness than the material of the magazine body, or a combination of materials with a greater hardness than the material of the magazine body. In some embodiments, the first insert 478 and the second insert 482 may be formed from hard anodized aluminum or stainless steel with a wear resistant coating, such that an outer surface of the inserts 478, 482 has a layer with much higher hardness than a center of the inserts 478, 482.

In the illustrated embodiment, a maximum thickness of the second side 366 is greater than a maximum thickness of the first side 362. In particular, and as shown in FIG. 8, the second side 366 between the opening 400 and the fourth side 374 has a thickness that is greater the first side 362 between the opening 400 and the fourth side 374. Even further, the second side 366 between the opening 400 and the tip portion 458 of the fastener channel 420 has a thickness that is greater the first side 362 between the opening 400 and the tip portion 458 of the fastener channel 420. In the illustrated embodiment, a maximum thickness of the second side 366 is 3.9 mm, while a maximum thickness of the first side 362 is 2.25 mm. In the illustrated embodiment, a maximum thickness of the second side 366 is at least 58% greater than a maximum thickness of the first side 362. In other embodiments, a maximum thickness of the second side 366 may be 44% to 60% greater than a maximum thickness of the first side 362. The fastener channel 420 of the magazine assembly 14 can receive fasteners 430 having a wide range of lengths. Because of this, a length of the magazine assembly 14 between the third side 370 and the fourth side 374 is sized to accommodate the different lengths. Because the magazine assembly 14 is longer than the fasteners 430, it may experience some deflection (i.e., on drops, etc.), especially when the fasteners 430 in the magazine assembly 14 are shorter in length. The greater thickness of the second side 362 helps to increase the stiffness of the magazine assembly 14 to prevent deflection (which is discussed below).

The magazine assembly 14 of FIGS. 2-3 and 7-10 may be manufactured using the following method. The method includes forming, by extrusion, the body 350, as discussed above. That is, body 350, formed by extrusion, includes the first end 354 configured to be coupled to the nosepiece 550, the second end 358 opposite the first end 354, the first side 362, the second side 366 opposite the first side 362, the third side 370, the fourth side 374 opposite the third side 370, and the fastener channel 420 extending between the first end 354 and the second end 358. Forming the body 350 by extrusion also enables the maximum thickness of the second side 366 being greater than the maximum thickness of the first side 362. The difference in thickness between the two sides is difficult to achieve using other methods. The other features, discussed above, of the body 350 are formed via extrusion.

The method also includes machining the body 350 to remove material from the first end 354, the second end 358, and at least one of the first side 362, the second side 366, the third side 370, and fourth side 374. Removal of material via machining reduces the weight of the magazine assembly 14 and enables adjustment of the height of the magazine assembly 14. Also, machining of the body 350 at the first end 354 allows the profile of the first end 354 to be couplable to the nosepiece 550. Machining of the body 350 at the second end 358 and at the fourth side 374 adjacent the second end 358 allows the profile of the second end 358 to be couplable to the end cap 376. Machining of the body 350 on the fourth side 374 adjacent the first end 354 and the second end 358 also causes the tip portion 458 of the fastener channel 420 to extend partially along the length from the first end 354 to the second end 358.

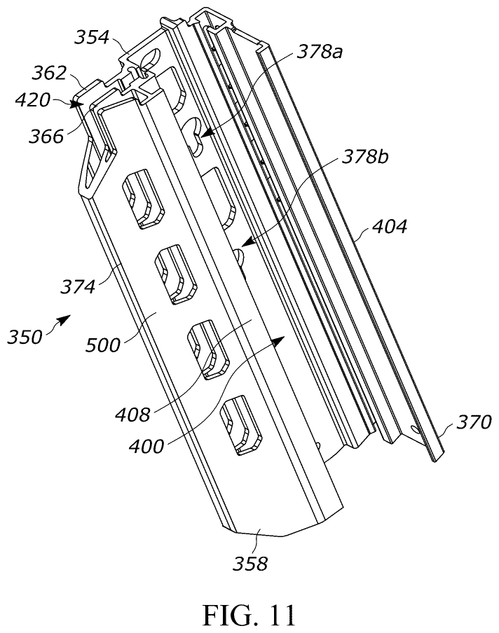

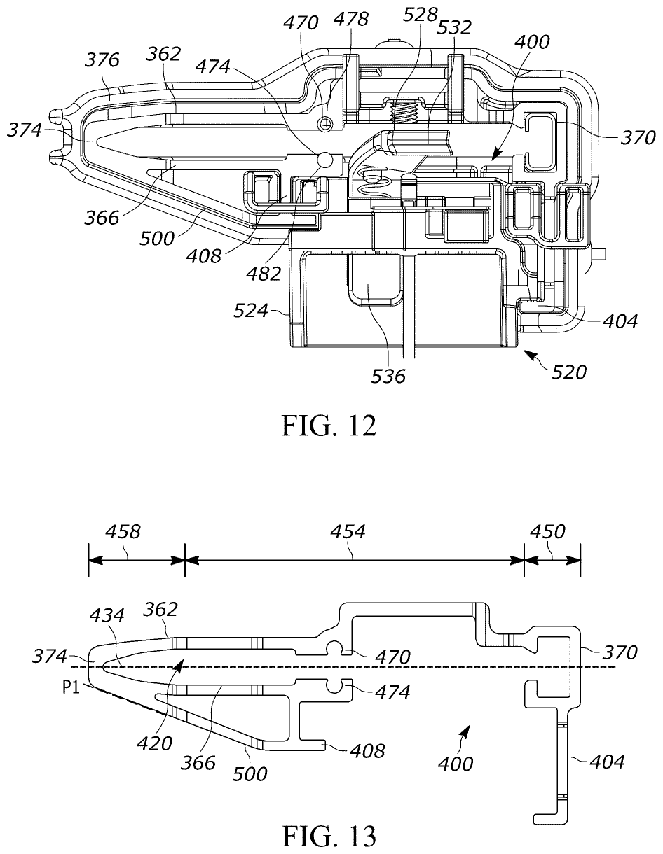

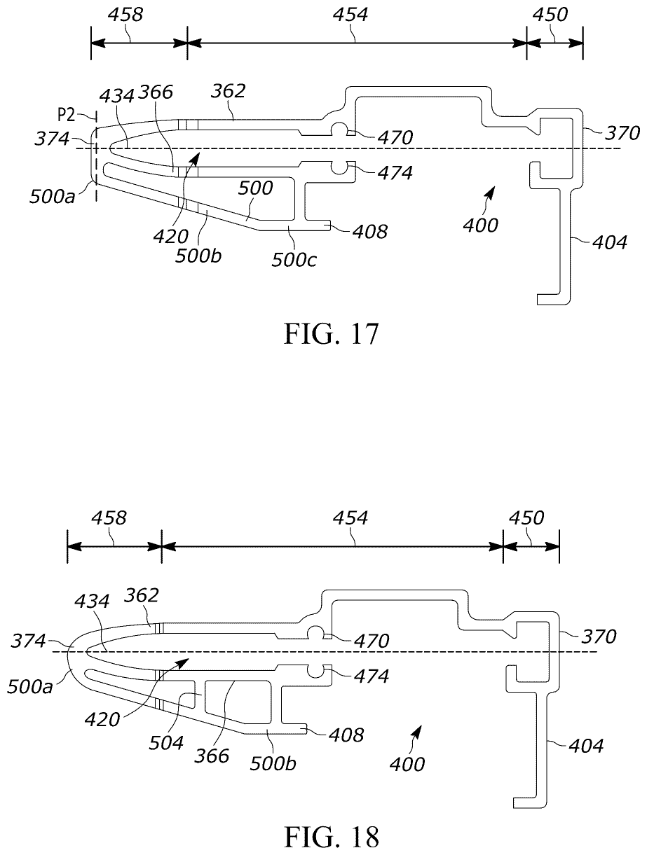

In some embodiments, as shown in FIGS. 11-20, the body 350 of the magazine assembly 14 may have a rib 500 extending therefrom. As shown, the rib 500 is coupled to the body 350 and the second rail 408. The rib 500 extends at least partially along the height of the magazine assembly 14. The rib 500 adds stiffness to the second side 366 of the magazine assembly 14 to prevent deflection (discussed above).

With respect to FIGS. 11-13, the rib 500 extends from the second side 366 to the second rail 408. The rib 500 extends from the second side 366 at an angle that is coincident with or otherwise parallel to a plane P1 of the second side 366. Also, the rib 500 extends at an acute angle relative to the axis 434 of the fastener channel 420. In this embodiment, the rib 500 is coupled to the second side 366 at a location that is between the shank portion 454 and the fourth side 374.

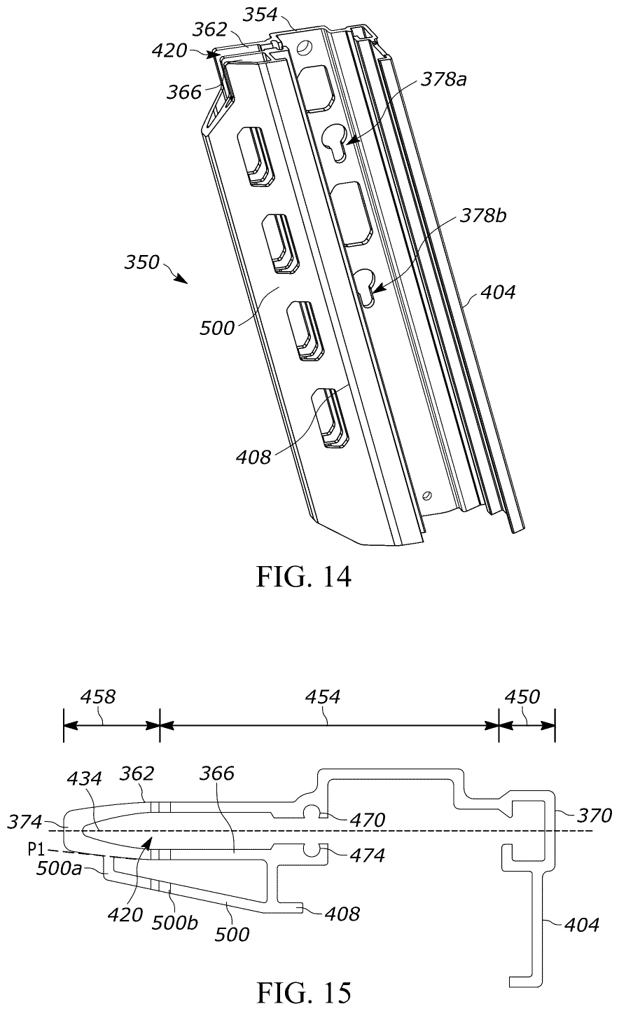

With respect to FIGS. 14-15, the rib 500 extends from the second side 366 to the second rail 408. The rib 500 includes a first portion 500a and a second portion 500b. The first portion 500a extends at a non-parallel and non-perpendicular angle relative to the plane P1 of the second side 366. Also, the first portion 500a of the rib 500 extends at a perpendicular angle relative to the axis 434 of the fastener channel 420. The second portion 500b extends at a non-parallel and non-perpendicular angle from the first portion 500a to the second rail 408. In this embodiment, the rib 500 is coupled to the second side 366 at a location that is between the shank portion 454 and the fourth side 374.

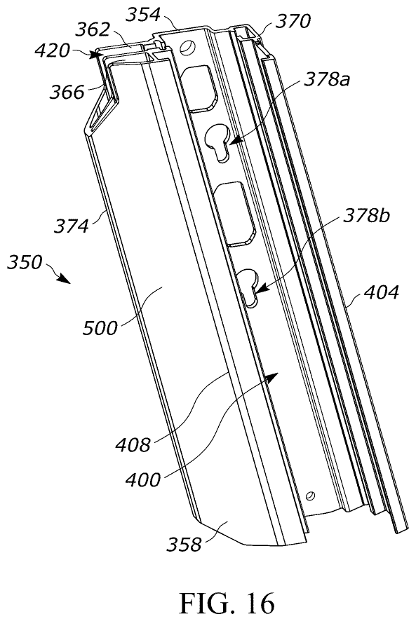

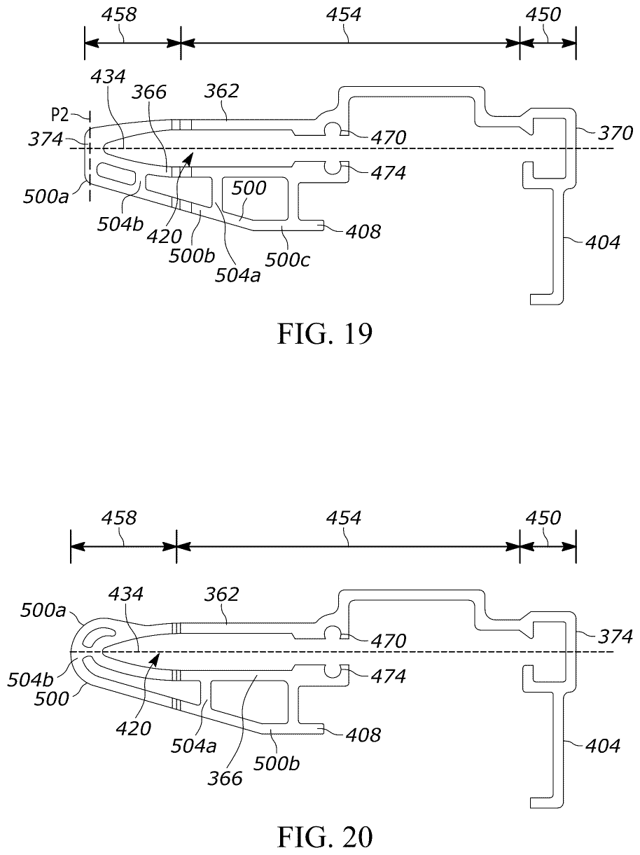

With respect to FIGS. 16, 17, 19, the rib 500 extends from the fourth side 374 towards the second side 366 to the second rail 408. The rib 500 includes a first portion 500a, a second portion 500b, and a third portion 500c. The first portion 500a is coincident with or otherwise parallel to a plane P2 of the fourth side 374, which is generally perpendicular to the axis 434. Thus, the first portion 500a of the rib 500 extends at a perpendicular angle relative to the axis 434 of the fastener channel 420, as well. The second portion 500b extends at a non-parallel and non-perpendicular angle from the first portion 500a towards the second rail 408. The third portion 500c extends at a non-parallel and non-perpendicular angle from the second portion 500b to the second rail 408. In this embodiment, the rib 500 is coupled to the second side 366 at a location that is between the shank portion 454 and the fourth side 374. With respect to FIG. 19, a first auxiliary wall 504a and a second auxiliary walls 504b may extend between the second side 366 of the body 350 and the rib 500. The auxiliary walls 504a, 504b extend partially along the height of the magazine assembly 14.

With respect to FIGS. 18 and 20, the rib 500 includes a first portion 500a and a second portion 500b. In these embodiments, the first portion 500a is an arcuate portion with a first end coupled to the body 350 of the magazine assembly 14 and a second end positioned adjacent to the second side 366 of the magazine assembly 14. The second portion 500b extends at a non-parallel and non-perpendicular angle from the first portion 500a to the second rail 408. In the embodiment of FIG. 18, the first end of the first portion 500a of the rib 500 is coupled to the fourth side 374. Also, an auxiliary wall 504 may extend between the body 350 and the rib 500. In the embodiment of FIG. 20, the first end of the first portion 500a of the rib 500 is coupled to the first side 362 at a location that is between the shank portion 454 and the fourth side 374. Also, a first auxiliary wall 504a and a second auxiliary wall 504b may extend between the body 350 and the rib 500. The first auxiliary wall 504a is positioned between the second side 366 of the body 350 and the rib 500, while the second auxiliary wall 504b is positioned between the fourth side 374 of the body 350 and the rib 500. The auxiliary walls 504, 504a, 504b extend partially along the height of the magazine assembly 14.

The magazine assemblies 14 of FIGS. 11-20 may be manufactured in a similar way to the embodiment of FIGS. 2-3 and 7-10. That is, the method may include forming, by extrusion, the body 350, including the ribs 500 (and associated structures), and machining the body 350 to remove material from the first end 354, the second end 358, and at least one of the first side 362, the second side 366, the third side 370, and fourth side 374.

As best shown in FIG. 2, the magazine assembly 14 further includes a pusher assembly 520. The pusher assembly 520 is slidably coupled to the magazine assembly 14 and configured to bias the fasteners 430 in the magazine assembly 14 toward the nosepiece 550. The pusher assembly 520 includes a pusher body 524 that is slidably supported by the first and second rails 404, 408 of the body 350 of the magazine assembly 14 and a pusher finger 528 pivotably supported by the pusher body 524. The increased thickness of the second side 366 shown in the embodiment of FIGS. 1-10 and the rib 500 of FIGS. 11-20 are therefore on the side that supports the pusher assembly 520.

The pusher finger 528 includes a first end 532 that is positioned between the pusher body 524 and the magazine assembly 14 and a second end 536 that extends outwardly from the pusher body 524. The pusher finger 528 is movable between an engaged position in which the first end 532 is positioned within the fastener channel 420 and configured to engage the last fastener 430 in the fastener channel 420 and a disengaged position in which the first end 532 is at least partially removed from the fastener channel 420. A spring 540 (FIGS. 9 and 10) biases the pusher finger 528 into the engaged position. A force exerted on the second end 536 of the pusher finger 528 temporarily moves the pusher finger 528 from the engaged position to the disengaged position such that the pusher assembly 520 is movable relative to the magazine assembly 14. When the force is removed from the second end 536 of the pusher finger 528, the bias of the spring 540 returns the pusher finger 528 to the engaged position. The first end 532 of the pusher finger 528 is configured to engage the last fastener 430 to push the fastener collation towards the nosepiece 550.

With reference to FIG. 5, the driver 10 further includes a nosepiece 550 positioned at the first end 354 of the magazine assembly 14. The nosepiece 550 forms a firing channel 554 (FIG. 5) in communication with the fastener channel 420 in the magazine assembly 14. The firing channel 554 is configured to consecutively receive fasteners 430 from a collated fastener strip within the fastener channel 420 of the magazine assembly 14. As stated above, the lifting assembly 42 moves the driver blade 26 from the driven position to the ready position. In the ready position of the driver blade 26, the driver blade 26 is positioned above the fastener channel 420 such that the fastener may be received within the firing channel 554 prior to initiation of a firing cycle.

The magazine assembly 14 is removably coupled to the nosepiece 550 to clear a fastener jam within the firing channel 554. The magazine assembly 14 is coupled to the housing 80 via the first bolt 390a and the second bolt 390b. The first bolt 390a is coupled to the first threaded aperture in the housing 80 and the second bolt 390b is coupled to the second threaded aperture in the housing 80. The magazine assembly 14 is movable relative to the housing 80, the nosepiece 550, and the first and second bolts 390a, 390b between a first position and a second position to remove the magazine assembly 14 from the driver 10. When the magazine assembly 14 is in the first position, the first bolt 390a and the second bolt 390b extend through the first portion 382a, 382b of the respective aperture 378a, 378b. When the magazine assembly 14 is in the second position, the first bolt 390a and the second bolt 390b extend through the second portion 386a, 386b of the respective aperture 378a, 378b.

When the magazine assembly 14 is in the first position, the bolts 390a, 390b can be tightened to secure the magazine assembly 14 to the housing 80. To remove the magazine assembly 14, the operator loosens the first bolt 390a and the second bolt 390b such the magazine assembly 14 can slide from the first position to the second position in a direction away from the nosepiece 550. With the bolts 390a, 390b positioned in the second portions 386a, 386b of the aperture 378a, 378b and the magazine assembly 14 spaced apart from the nosepiece 550 the magazine assembly 14 can be lifted away from the housing 80 such that the heads of the bolts 390a, 390b pass through the second portion 386a, 386b of the respective aperture 378a, 378b. In this way, the first bolt 390a and the second bolt 390b need not be removed from the housing 80 to remove the magazine assembly 14 from the housing 80 and the nosepiece 550.

With reference to FIGS. 4A-4C, the driver 10 further includes a latch assembly 560 having a pawl or latch 564 for selectively holding the driver blade 26 in an intermediate position located between the BDC position and the ready position against a biasing force (i.e., the pressurized gas in the storage chamber cylinder 30) (i.e., for clearing a jam, etc.). The intermediate position may be any position at which the driver blade 26 stops between the BDC position and the ready position. A separate actuator 568 is provided for releasing the latch assembly 560 from the driver blade 26. In other words, the latch assembly 560 is moveable between a latched state in which the driver blade 26 is held in the intermediate position (e.g., for clearing a jam, etc.), and a released state in which the driver blade 26 is permitted to be driven by the biasing force toward the driven position. The actuator 568 is referred to herein as a latch actuator assembly. In particular, the latch actuator assembly 568 is integrated with the lifting assembly 42 for selectively moving the latch 564 from the latched position to the released position. The latch assembly 560 is mechanically operated by the latch actuator assembly 568, rather than electrically operated such as via a solenoid, for controlling the movement of the latch 564. Additional details of the latch assembly 560 and the latch actuator assembly 568 are discussed in U.S. Patent Publication No. 2022/0134525, which is incorporated by reference herein.

With reference to FIGS. 2 and 4A, the driver 10 further includes an arm member 580 positioned on an end 584 of the nosepiece 550. The arm member 580 includes a first end 588 and a second end 592 positioned opposite the first end 588 along the driving axis 38. The first end 588 is proximate the end 584 and configured to engage the workpiece. The second end 592 may be connected to a depth of drive adjustment mechanism 596. Specifically, a depth that the arm member 580 extends relative to the end 584 of the nosepiece 550 is adjustable using the depth of drive adjustment mechanism 596.

With reference to FIG. 5, the driver 10 includes a bumper 610 positioned beneath the piston 22 for stopping the piston 22 at the driven position (FIG. 6A) and absorbing the impact energy from the piston 22. The bumper 610 is configured to distribute the impact force of the piston 22 uniformly throughout the bumper 610 as the piston 22 is rapidly decelerated upon reaching the driven position (i.e., the bottom dead center position).

With reference to FIGS. 6A-6B, the operation of a firing cycle for the driver 10 is illustrated and detailed below. With reference to FIGS. 6B, prior to initiation a firing cycle, the driver blade 26 is held in the ready position with the piston 22 near top dead center within the cylinder 18. More specifically, the bushing 284 associated with the driver pin 276 on the lifter 100 is engaged with a lower-most tooth 310A of the axially spaced teeth 310 on the driver blade 26, and the rotational position of the lifter 100 is maintained by a one-way clutch mechanism (not shown) of the transmission. Also, in the ready position of the driver blade 26, the latch 564 is engageable with a lower-most projection 318A on the driver blade 26, though not necessarily in contact with and functioning to maintain the driver blade 26 in the ready position. Rather, the latch 564 at this instant provides a safety function to prevent the driver blade 26 from inadvertently firing should the one-way clutch mechanism of the transmission fail.

In operation, as shown in FIG. 4C, the lowermost tooth 310A of the teeth 310 is in engagement with one of the drive pins 276 for holding the driver blade 26 in the ready position. In addition, when the driver blade 26 is in the ready position, the latch 564 is in contact with (e.g., resting on) a lowermost one of the projections 318A. Upon the trigger 48 being pulled to initiate a firing cycle, the motor 46 is activated to rotate the transmission output shaft 96 and the lifter 100 in a counter-clockwise direction from the frame of reference of FIGS. 4A-4C, thereby displacing the driver blade 26 upward past the ready position a slight amount before the lower-most tooth 310A on the driver blade 26 slips off the driver pin 276 (at the TDC position of the driver blade 26). Because the roller bushings 284 are rotatable relative to the driver pins 276 upon which they are supported, subsequent wear to the driver pin 276 and the teeth 310 is reduced. As the driver blade 26 moves from the ready position toward the TDC position, the latch 564 first moves toward and contacts the second side 322 of the driver blade 26 before moving away from the driver blade 26 toward the released position. The latch 564 is moved completely out of the way as the driver blade 26 reaches the TDC position. Thereafter, the piston 22 and the driver blade 26 are thrust downward toward the driven position (FIG. 6B) by the expanding gas in the cylinder 18 and storage chamber cylinder 30. As the driver blade 26 is displaced toward the driven position, the motor 46 remains activated to continue counter-clockwise rotation of the lifter 100. With reference to FIGS. 4A and 4B, the latch actuator assembly 568 is configured to maintain the latch 564 in the released position as the driver blade 26 moves from the TDC position to the BDC position.

With reference to FIG. 5, upon a fastener being driven into a workpiece, the piston 22 impacts the bumper 610 to quickly decelerate the piston 22 and the driver blade 26, eventually stopping the piston 22 in the driven or bottom dead center position.

Shortly after the driver blade 26 reaches the driven position, a first of the driver pins 276 on the lifter 100 engages one of the teeth 310 on the driver blade 26 and continued counter-clockwise rotation of the lifter 100 raises the driver blade 26 and the piston 22 toward the ready position. Shortly thereafter and prior to the lifter 100 making one complete rotation, the latch actuator assembly 568 permits the latch 564 to re-engage the driver blade 26 and ratchet around the projections 318 as upward displacement of the driver blade 26 continues (defining the latched state of the latch assembly 560).

After one complete rotation of the lifter 100 occurs, the latch 564 maintains the driver blade 26 in an intermediate position (FIGS. 4B and 4C) between the driven position and the ready position while the lifter 100 continues counter-clockwise rotation (from the frame of reference of FIG. 4A). Continued rotation of the lifter 100 raises the driver blade 26 to the ready position.

Although the invention has been described in detail with reference to certain preferred embodiments, variations and modifications exist within the scope and spirit of one or more independent aspects of the invention as described.

Various features of the invention are set forth in the following claims.

1. A magazine assembly for use with a powered fastener driver including a nosepiece, the magazine assembly comprising:
a body having a first end configured to be coupled to the nosepiece, a second end opposite the first end, a first side, a second side opposite the first side, a third side, and a fourth side opposite the third side, and a rib extending from the body and positioned adjacent to the second side,
a fastener channel extending between the first end and the second end, the fastener channel configured to receive fasteners,
a first elongate channel positioned in the first side of the body and extending between the first end and the second end, the first elongate channel opens to the fastener channel,
a second elongate channel positioned in the second side of the body and extending between the first end and the second end, the second elongate channel opens to the fastener channel, the first elongate channel and the second elongate channel being on an opposite sides of the fastener channel;
a first insert positioned within the first elongate channel and partially extending into the fastener channel, and
a second insert positioned within the second elongate channel and partially extending into the fastener channel.

2. The magazine assembly of claim 1, wherein the body is formed from magnesium, aluminum, steel, or plastic.

3. The magazine assembly of claim 2, wherein the first insert and the second insert are formed from hard anodized aluminum, steel, stainless steel, or plastic.

4. The magazine assembly of claim 1, wherein the body further includes a first rail and a second rail that extend from the second side of the body, the first rail and the second rail configured to support a pusher body of a pusher assembly such that the pusher body is slidable along the body of the magazine assembly, and wherein the rib extends between the body and the second rail.

5. The magazine assembly of claim 4, wherein the fastener channel has an axis and extends from the second side at an acute angle relative to the axis of the fastener channel.

6. The magazine assembly of claim 1, wherein the fastener channel includes a head portion extending from the third side towards the fourth side and configured to receive heads of the fasteners, a shank portion extending from the head portion towards the fourth side and configured to receive shanks of fasteners, and a tip portion extending from the shank portion to the fourth side and in which tips of the fasteners may be received, and wherein the first elongate channel and the second elongate channel are positioned on opposite sides of the shank portion of the fastener channel.

7. The magazine assembly of claim 1, wherein the fastener channel has an axis and extends from the second side at an acute angle relative to the axis of the fastener channel.

8. A powered fastener driver comprising:
a housing;
a nosepiece extending from the housing and including a firing channel from which consecutive fasteners are driven;
a magazine assembly including
a body having a first end coupled to the nosepiece, a second end opposite the first end, a first side, a second side opposite the first side, a third side, and a fourth side opposite the third side, the first side including an aperture extending therethrough, the aperture including a first portion and a second portion, a maximum width of the second portion being greater than a maximum width of the first portion,
a fastener channel extending between the first end and the second end, the fastener channel configured to receive fasteners and in communication with the firing channel,
a first elongate channel positioned in the first side of the body and extending between the first end and the second end, the first elongate channel opens to the fastener channel,
a second elongate channel positioned in the second side of the body and extending between the first end and the second end, the second elongate channel opens to the fastener channel, the first elongate channel and the second elongate channel being on an opposite sides of the fastener channel,
a first insert positioned within the first elongate channel and partially extending into the fastener channel, and
a second insert positioned within the second elongate channel and partially extending into the fastener channel;
a bolt threadably coupled to a threaded aperture in the housing,
wherein the magazine assembly is removable from the nosepiece,
wherein magazine assembly is movable relative to the housing, the nosepiece, and the bolt between a first position and a second position,
wherein when the magazine assembly is in the first position, the bolt extends through the first portion of the aperture and when the magazine assembly is in the second position, the bolt extends through the second portion of the aperture, and
wherein when the magazine assembly is in the first position, the magazine assembly is securable to the housing by the bolt to the housing, and when the magazine assembly is in the second position, the magazine assembly is removable from the housing.

9. The powered fastener driver of claim 8, wherein the body is formed from magnesium, aluminum, steel, or plastic.

10. The powered fastener driver of claim 9, wherein the first insert and the second insert are formed from hard anodized aluminum, steel, stainless steel, or plastic.

11. The powered fastener driver of claim 8, wherein the body further includes a rib extending from the body and positioned adjacent to the second side.

12. The powered fastener driver of claim 11, wherein the body further includes a first rail and a second rail that extend from the second side of the body, the first rail and the second rail configured to support a pusher body of a pusher assembly such that the pusher body is slidable along the body of the magazine assembly, and wherein the rib extends between the body and the second rail.

13. The powered fastener driver of claim 8, wherein a maximum thickness of the second side is greater than a maximum thickness of the first side.

14. The powered fastener driver of claim 8, wherein the fastener channel includes a head portion extending from the third side towards the fourth side and configured to receive heads of the fasteners, a shank portion extending from the head portion towards the fourth side and configured to receive shanks of fasteners, and a tip portion extending from the shank portion to the fourth side and in which tips of the fasteners may be received, and wherein the first elongate channel and the second elongate channel are positioned on opposite sides of the shank portion of the fastener channel.

15. The powered fastener driver of claim 14, wherein a maximum thickness of the second side is greater than a maximum thickness of the first side.

16. A magazine assembly for use with a powered fastener driver including a nosepiece, the magazine assembly comprising:
a body having a first end configured to be coupled to the nosepiece, a second end opposite the first end, a first side, a second side opposite the first side, a third side, and a fourth side opposite the third side, a maximum thickness of the second side being greater than a maximum thickness of the first side;
a fastener channel extending between the first end and the second end, the fastener channel configured to receive fasteners;
a first elongate channel positioned in the first side of the body and extending between the first end and the second end, the first elongate channel opens to the fastener channel,
a second elongate channel positioned in the second side of the body and extending between the first end and the second end, the second elongate channel opens to the fastener channel, the first elongate channel and the second elongate channel being on an opposite sides of the fastener channel;
a first insert positioned within the first elongate channel and partially extending into the fastener channel; and
a second insert positioned within the second elongate channel and partially extending into the fastener channel.

17. The magazine assembly of claim 16, wherein the fastener channel includes a head portion extending from the third side towards the fourth side and configured to receive heads of the fasteners, a shank portion extending from the head portion towards the fourth side and configured to receive shanks of fasteners, and a tip portion extending from the shank portion to the fourth side and in which tips of the fasteners may be received, and wherein the first elongate channel and the second elongate channel are positioned on opposite sides of the shank portion of the fastener channel.

18. The magazine assembly of claim 16, wherein the body is formed from magnesium, aluminum, steel, or plastic.

19. The magazine assembly of claim 18, wherein the first insert and the second insert are formed from hard anodized aluminum, steel, stainless steel, or plastic.

20. The magazine assembly of claim 16, wherein the maximum thickness of the second side is 44% to 60% greater than the maximum thickness of the first side.

21-26. (canceled)
